(19) United States
(12) Patent Application Publication
(10) Pub. No.: US 2026/0158682 A1
(43) Pub. Date: Jun. 11, 2026

(54) MINIATURE BIMANUAL MANIPULATION SYSTEM

(71) Applicant: The Trustees of Columbia University in the City of New York, New York, NY (US)

(72) Inventors: Matei Ciocarlie, New York, NY (US); Sharfin Islam, New York, NY (US)

(21) Appl. No.: 19/410,812

(22) Filed: Dec. 5, 2025

Related U.S. Application Data
(60) Provisional application No. 63/728,833, filed on Dec. 6, 2024.

(51) Int. Cl. B25J 18/04; B25J 9/02; B25J 15/00; B25J 17/00

(52) U.S. Cl. CPC B25J 18/04; B25J 9/02; B25J 15/0052; B25J 17/00

(57) ABSTRACT

A manipulator, comprising: a support arm and an arm support mount associated with the support arm; a first arm and a first end effector associated with the first arm, the first arm comprising a plurality of joints arranged such that the first arm is moveable with a plurality of degrees of freedom, the plurality optionally being from 3 to 6 degrees of freedom; a second arm and a second end effector associated with the second arm, the second arm comprising a plurality of joints arranged such that the second arm is moveable with a plurality of degrees of freedom, the plurality optionally being from 3 to 6 degrees of freedom, and the first arm and the second arm extending from the arm support mount. A manipulator, comprising: an articulated support arm; an articulated first arm extending from the articulated support arm, the articulated first arm comprising a first end effector; and an articulated second arm extending from the articulated support arm, the articulated second arm comprising a second end effector, the articulated first arm and the articulated second arm being arranged so as to define a plurality of degrees of freedom between the articulated first arm and the articulated second arm, the plurality of degrees of freedom optionally being from 6 to 12 degrees of freedom.

### RELATED APPLICATIONS

The present application claims priority to and the benefit of U.S. patent application No. 63/728,833, “Miniature Bimanual Manipulation System,” filed Dec. 6, 2024. All foregoing applications are incorporated herein by reference in their entireties for any and all purposes.

### GOVERNMENT RIGHTS

This invention was made with government support under 2037101 awarded by the National Science Foundation. The government has certain rights in the invention.

### TECHNICAL FIELD

The present disclosure relates to the field of mechanical manipulator devices and methods.

### BACKGROUND

Bi-manual manipulation systems show impressive dexterity, despite the end-effectors lacking any form of intrinsic dexterity. These systems demonstrate that two simple parallel grippers can accomplish diverse, dexterous manipulation tasks. However, the dual-arm bi-manual systems are bulky, expensive, and make poor use of the hardware, since the two grippers are near each other only in a fraction of each arm's workspace. Accordingly, there is a long-felt need in the art for improved manipulation systems and related methods.

### SUMMARY

In meeting the described long-felt needs, the present disclosure provides a manipulator, comprising: a support arm and an arm support mount associated with the support arm; a first arm and a first end effector associated with the first arm, the first arm comprising a plurality of joints arranged such that the first arm is moveable with a plurality of degrees of freedom, the plurality optionally being from 3 to 6 degrees of freedom; a second arm and a second end effector associated with the second arm, the second arm comprising a plurality of joints arranged such that the second arm is moveable with a plurality of degrees of freedom, the plurality optionally being from 3 to 6 degrees of freedom, and the first arm and the second arm extending from the arm support mount.

Also provided is a manipulator, comprising: an articulated support arm; an articulated first arm extending from the articulated support arm, the articulated first arm comprising a first end effector; and an articulated second arm extending from the articulated support arm, the articulated second arm comprising a second end effector, the articulated first arm and the articulated second arm being arranged so as to define a plurality of degrees of freedom between the articulated first arm and the articulated second arm, the plurality of degrees of freedom optionally being from 6 to 12 degrees of freedom.

Further disclosed is a method, comprising operating a manipulator according to the present disclosure so as to effect a motion of an object engaged by the manipulator.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1B. The disclosed technology (FIG. 1B) compared to traditional bi-manual manipulators (FIG. 1A).

FIG. 2: Workspace plots for an 8-DOF Mini-BE configuration. Green represents point in space where there is an inverse kinematic solution and meets the specified orientation criteria. The points are all relative to the frame of the fixed left end-effector, shown with the red coordinates. Arbitrarily setting each link to 100 mm, we then evaluate this 8-DOF design with our evaluation method explained elsewhere herein. We can reach almost every single point in our desired space, as shown in (1). Joint J R is designed so that we can easily reorient objects. We see in (2) that removing the joint can affect the usable workspace.

FIG. 3: Workspace plots for a 6-DOF Mini-BE configuration, with no redundant degrees of freedom. Setting all lengths of links to 100 mm and evaluating this configuration, we only 47.5% of the desired workspace. Selecting the lengths, therefore, for this 6-DOF configuration can influence manipulator performance.

FIG. 4. Overview of disclosed technology. The MiniBEE is an example embodiment of the disclosed technology and is a bimanual end-effector consisting of two compact arms equipped with grippers. The kinematic chain connecting the two grippers has sufficient degrees of freedom so that, with careful kinematic optimization, the two grippers have full manipulability with respect to each other, enabling high dexterity. The MiniBEE is compact enough to be worn and operated for kinesthetic data collection (left) for behavioral cloning, and the trained policies can be deployed with the MiniBEE mounted on a standard robot arm (right), giving the overall system a large reach to combine with its dexterity.

FIG. 5. Overview of MiniBEE concept. Here, one uses a bimanual system designed to mount on a larger robot arm. When designing the MiniBEE, one can rely on a kinematic convention that treats one gripper as the base coordinate frame (the “fixed” gripper) and the other as the tip of the chain (the “free” gripper). Rather than computing each gripper's pose relative to a robot tool frame (blue), one can then solve kinematic queries directly between the two grippers, relying on the fact that the complete kinematic chain connecting them (red) has sufficient DOFs for relative dexterity.

FIG. 6. One can evaluate the kinematic dexterity between two grippers of a bi-manual kinematic chain. One of the grippers in the chain, dubbed the fixed gripper, serves as the base of our coordinate frame. One can then set a desired volume for a workspace around the fixed gripper uniformly sample a set of points in this volume. One can use each of these points as a desired position for the “free” gripper, oriented such that it points towards the fixed gripper (bottom image). If an IK solution for this query exists, obeys joint limits and self-collisions, and does not place the robot near a singularity, one can consider the query point as reachable. The ratio of reachable to non-reachable points in the workspace is used as a metric for the relative kinematic dexterity between two grippers that are connected by a single kinematic chain.

FIG. 7. Kinematic analysis for example MiniBEE configurations as well as a state of the art bimanual system. For each configuration, one can follow the procedure outlined in Algorithm 1 to compute the KD-metric for a desired fixed rectangular workspace with a side length of 20 cm. Successful desired points in the workspace are shown in green, points skipped due to IK solutions being near singularities are shown in blue, and points where there are no collision-free IK solutions are shown in red. The 8-DOF MiniBEE performed the best, as expected, and was comparable in performance to traditional bimanual systems that use two full mobility arms. Reducing the configuration to 7 and 6-DOF reduced the dexterity score significantly. For the illustrated experiments, the 8-DOF configuration was used, as that provided the best balance between complexity, size, and performance.

FIG. 8. A set of three manipulation experiments with MiniBEE. The first task, shown in the first row, is to grasp an object from the table, reorient it by handing it off to the other gripper, and place it on the table in a different pose. The second task, shown in the second row, is for MiniBEE to pick up a pair of folded sunglasses from the table, unfold them with the other gripper, and then place on a display rack. The third task is to pick up a closed pill bottle, unscrew the cap, pick up a bowl with the other gripper, and then empty the contents of the bottle into the bowl. MiniBEE performs these task with a high rate of success, and overall this set of experiments highlights the ability for the disclosed design to achieve bi-manual dexterity.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

### INTRODUCTION

Bi-manual manipulation systems show impressive dexterity, despite the end-effectors lacking any form of intrinsic dexterity. These systems demonstrate that two simple parallel grippers can accomplish diverse, dexterous manipulation tasks. However, the dual-arm bi-manual systems are bulky, expensive, and make poor use of the hardware, since the two grippers are near each other only in a fraction of each arm's workspace.

Here, we provide a novel bi-manual manipulation system that enables dexterity in a majority of the total system's workspace. The disclosed design can include a single arm—which can be an off-the-shelf robot arm—and a novel, mini bi-manual end-effector, which is termed “Mini-BE.”

Mini-BE can include two miniature arms, each with at least 3 degrees of freedom, and also include simple grippers as end effectors. An end effector need not, however, be a gripper.

The disclosed design provides a number of advantages. First, it ensures at least 6 degrees of freedom between the two grippers, meaning that one gripper can be positioned arbitrarily relative to the other for fine manipulation. Second, the single large, the off-the-shelf arm can provide overall reach for the entire system, reducing cost compared to existing systems which use two such arms.

Bi-manual manipulation systems can achieve dexterous, contact-rich manipulation tasks, despite lacking any form of intrinsic dexterity at the end-effectors. The traditional, dual-arm bi-manual system has two robot arms, both equipped with simple parallel grippers. These bi-manual systems often rely purely on position-controlled motors at the joints and end-effectors.

Without complex mechanisms and intricate electronics, these systems are mostly composed of rigid links and position-controlled servos—leading to simple, reliable, and robust hardware. By using precise off-the-shelf servos, these systems also lend themselves to sim-to-real transfer. Despite all these advantages of bi-manual manipulation, there are several improvements that can be made to the dual-arm framework.

Besides advancements in actuators, bi-manual manipulation systems have seen little progress in their design over the last few decades. Most systems still follow the dual-arm framework. They are composed of two arms, each with at least 6 degrees of freedom, and an actuated gripper as end-effectors. The link lengths of these arms can determine the shared workspace between the two arms. Within this shared space, there is a small manifold in which the two grippers are near each other and have enough flexibility to manipulate an object. The problem with traditional dual-arm systems is that this dexterous manifold is a very small portion of the total shared workspace between the two arms. The only way to expand this space is to make both of the arms very long and space the bases far apart, which is not possible in applications such as mobile manipulation. To build more bi-manual manipulation systems that are more efficient with their use of space, we diverge from the traditional dual-arm mold.

In this disclosure, we provide a novel bi-manual manipulation system that will allow us to dexterously manipulate objects in a much larger area. An exemplary, non-limiting embodiment of the system uses a single robot arm and attaches a novel mini bi-manual end-effector, which we are calling Mini-BE.

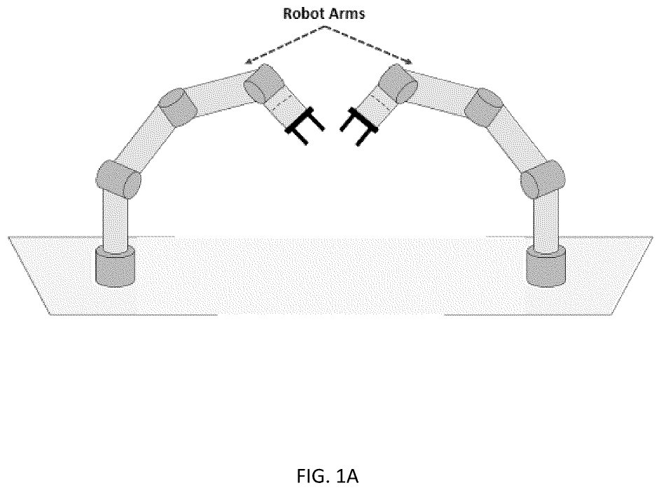

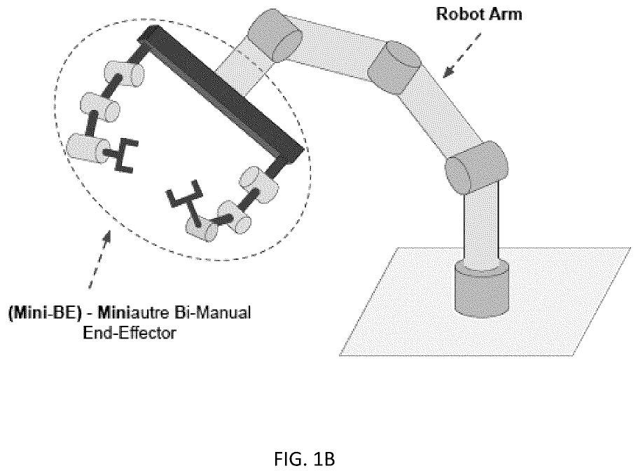

As shown in FIG. 1, an example system can include two miniature arms with compact actuated grippers as end-effectors. With this design, the grippers are always near each other, so that the shared, dexterous manifold can be translated anywhere in the larger robot arm's workspace.

Without being bound to any particular theory or embodiment, the advantages of the Mini-BE approach include:

Each of the two mini-arms of the Mini-BE has at least three Degrees of Freedom (DoFs). This means that the two grippers have six DoFs relative to each other. In turn, this means that the grippers can be positioned arbitrarily relative to each other using only the intrinsic DoFs of the Mini-BE.

The larger, off-the-shelf robot arm can then be used to move the entire Mini-BE around a larger workspace, providing it with greater reach.

With the advancements in learning based approaches, recent bi-manual manipulation systems are able to achieve complex, dexterous motor skills. The end-effectors in these systems lack any form of intrinsic dexterity, which leads to simple and reliable hardware for sim-to-real transfer of dexterous policies. For example, one example mobile dual arm manipulation system accomplishes a variety of household tasks such as clearing a dishwasher and organizing the items in a drawer. The so-called ALOHA system shows that simple dual-arm systems can achieve very fine-grained, precise dexterity. The tasks they complete range from opening a soda can and pouring it into a cup to tying shoe laces. Recently, a mobile-ALOHA was introduced in which a so-called ALOHA system was fixed onto a mobile platform.

Placing two arms on a mobile manipulation platform introduces significant challenges. For example, a mobile robotic system can be complicated with a total of 31-DOF. Each arm has 9-DOF that are attached to a 5-DOF torso that extends to increase the robot's reach; this level of redundancy was introduced so the grippers could operate in a larger space. In contrast, mobile-ALOHA brings the bases of both arms much closer than in a fixed dual-arm system and kept the same degrees of freedom. With the arms much closer together, the portion of their shared workspace that they can use for dexterous manipulation becomes much smaller. Both of these systems had to work around the innate limitations of the traditional dual-arm robot. The proposed bi-manual framework in this paper diverges from the dual-arm model to avoid these challenges.

### Methods

### Miniature Bi-Manual Manipulator Concept

In the disclosed design, illustrated in non-limiting FIG. 1, the end-effector itself is bi-manual. Although our system does not have two-arms, it is still bi-manual as it has two grippers that coordinate to manipulate objects and complete dexterous tasks.

This concept has several advantages over the traditional dual-arm system. First, using a single robot arm takes up much less space than two arms. Second, the grippers are always near each other as they are fixed to the end-effector of the robot arm—allowing us to manipulate objects anywhere in the arm's workspace.

Mini-BE can be a bi-manual end-effector that can be fitted on the tool frame of any robotic platform, including compact mobile manipulation systems. Because Mini-BE can be comparatively compact, it can be used in a diverse range of applications. Therefore, one may wish to limit the number of motors and links in Mini-BE's two miniature arms. However, the grippers or other end effectors must also have enough degrees of freedom between them to reposition and reorient themselves relative to each other. Therefore, one may want to ensure that the each arm has at least 3-DOF, which gives the grippers 6-DOF relative to each other.

### Evaluating Kinematic Designs

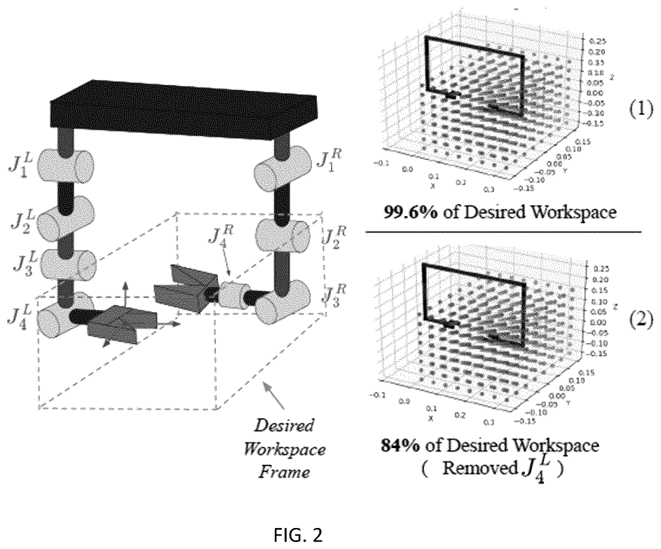

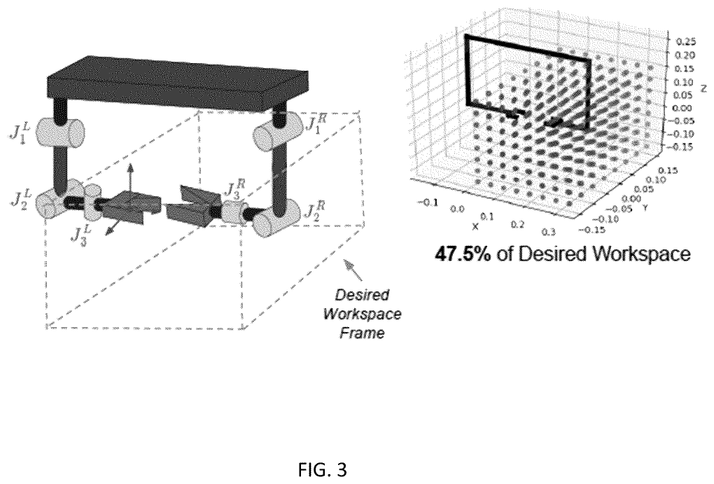

To evaluate a given kinematic design, one can consider a frame of reference where one gripper is fixed at the origin while the other is free to move in space. One can set the size of a desired workspace, illustrated with a green box in FIGS. 2 and 3. The size of our fixed workspace can, for example, be a prism set to be 300 mm in height, length, and width.

One can evaluate a given design by first discretizing the desired workspace into N points. At each point, one can search for an inverse kinematic solution such that the free gripper is pointing directly at the origin (i.e. the fixed gripper). One can then check if one can reorient the free gripper by 450 along any axis at the given point in the workspace. If there exists inverse kinematic solutions that satisfy our constraints, then one can consider that as a valid point.

### Design

One may want the grippers or other end effectors to position themselves in any position in a desired region between them and also for them to reorient themselves along any axis at any point within a given range. One may also wish to keep the design as light and compact as possible. Therefore, one can minimize the degrees of freedom to reduce the number of servos and links.

We begin exploring Mini-BE's design space with the kinematic configuration shown in FIG. 2. This design has 8-DOF, which one can expect to completely span our desired workspace and meet our re-orientation criteria. One can arbitrarily set the lengths of all links in this configuration to 100 mm and then evaluate this design. The design addresses 99.5% of the desired workspace. At all these points, it can also adjust its orientation along any axis by 45°, as stated elsewhere herein. One feature in this configuration is the third joint on the right arm. It allows for continuous rotation of the gripper, which helps meet our 450 reorientation criteria. In fact, by removing this degree of freedom, our workspace reduces to 84% of the desired space. One may therefore want to keep this degree of freedom in the 6-DOF version shown in FIG. 3.

In FIG. 3, we show a 6-DOF Mini-BE that still keeps continuous rotation of the gripper on one arm. Removing the redundancy in our design, one might expect that there will be less valid points in our desired workspace. Setting the link lengths all to 100 mm, we can only cover 47.5% of the desired workspace.

### Conclusion

Provided here is a novel miniature bi-manual end-effector, which we are calling Mini-BE. Mini-BE is composed of two small arms with parallel-grippers. When attached to a larger robot arm, this end-effector addresses the limitations of traditional dual-arm bi-manual systems. Mini-BE still allows for coordinated movement between two grippers. However, the advantage of our approach is that the grippers are always near each other and their shared workspace can be translated anywhere in the larger robot arms workspace. This novel approach is more compact than a traditional dual-arm manipulation system and can manipulate objects in a much larger space.

### Additional Disclosure

Bimanual robot manipulators can achieve impressive dexterity, but typically rely on two full six- or seven-degree-of-freedom arms so that paired grippers can coordinate effectively. This traditional framework increases system complexity while only exploiting a fraction of the overall workspace for dexterous interaction. As an example of the disclosed technology, we introduce here the MiniBEE (Miniature Bimanual End-Effector), a compact system in which two reduced-mobility arms (3+ DOF each) are coupled into a kinematic chain that preserves full relative positioning between grippers. To guide the design, one can formulate a kinematic dexterity metric that enlarges the dexterous workspace while keeping the mechanism lightweight and wearable. The resulting system supports two complementary modes: (i) wearable kinesthetic data collection with self-tracked gripper poses, and (ii) deployment on a standard robot arm, extending dexterity across its entire workspace. We present kinematic analysis and design optimization methods for maximizing dexterous range, and demonstrate an end-to-end pipeline in which wearable demonstrations train imitation learning policies that perform robust, real-world bimanual manipulation.

In recent years, bimanual robotic manipulators have shown remarkable dexterity. The combination of imitation learning from human demonstrations and two well-articulated kinematic chains has enabled such systems to use simple parallel grippers to autonomously perform highly dexterous tasks, with robustness to initial conditions or perturbations encountered during execution.

To achieve these results, current systems typically rely on the combination of two 6- or 7-degree-of-freedom (DOF) robotic arms. The dexterous workspace of the overall system, defined here as the space where the two grippers have complete positioning ability with respect to each other, thus lies at the intersection of the two arms' individual workspaces. As a result, this dexterous workspace is relatively small, and only covers a fraction of each arm's overall individual workspace. Moreover, this dexterous workspace is fixed relative to the base of the entire system, meaning any object must be brought into this portion of the system's workspace to be manipulated. Overall, this framework for bimanual manipulation is capable of dexterity, but has limitations in terms of footprint and overall portability.

In this paper, we propose a new approach to bimanual dexterity that aims to address the challenges described above for bimanual systems while preserving many of their benefits. Our fundamental insight is as follows. If each of the arms of a bimanual system has reduced mobility (three+ DOF), the kinematic chain connecting the two grippers still has sufficient articulation (6+ DOF) to allow arbitrary positioning of the grippers with respect to each other, and, with careful kinematic design, we can ensure that the dexterous workspace of the overall system is large enough for bimanual tasks. We dub our system the MiniBEE, for Miniature Bimanual End-effector.

Thanks to the reduced articulation of each individual arm, the overall MiniBEE remains compact and lightweight. In turn, this provides several benefits.

The MiniBEE can be worn directly by an operator, allowing for easy and highly mobile kinesthetic data collection. When this data is used to train autonomous policies, the encoders in the kinematic chain provide full information on the relative pose of the two grippers, removing the need for external tracking or SLAM while the MiniBEE is manipulating an object held in or transferred between its grippers.

The MiniBEE can also be mounted on a commodity robot arm, for example when a trained policy is deployed. This means that the entire reachable area of the robot arm instantly becomes available for the MiniBEE, and the dexterous workspace (i.e. the area where the two grippers have complete positioning authority with respect to each other) is scaled by the overall reach of the robot arm.

The MiniBEE functions both as wearable mechanism for easy data collection with self-tracking dexterity, and as a bimanual end-effector allowing a single traditional robot arm to become dexterous over the entirety of its workspace. This design presents a number of contributions:

To the best of our knowledge, this is the first example of reduced mobility arms enabling full relative mobility for bimanual tasks in a system that is compact enough for wearable collection of kinesthetic demonstrations.

Provided is a kinematic analysis tool that allows a designer to maximize the dexterous workspace while limiting the total number of DOF, and use these to compare multiple possible design variants.

Demonstrated here is the end-to-end pipeline consisting of wearable kinesthetic data collection followed by training standard imitation learning policies which leverage the proprioceptive component of the demonstrations to achieve robust, dexterous bimanual manipulation with large reach in the real world.

Bimanual systems offer several advantages for high dexterity, such as accessible off-the-shelf hardware and reliable joint control. With the appropriate kinematic structure and control policy, such systems can perform a wide range of dexterous robotic tasks. A central challenge, however, lies in teaching robots such coordination. With recent advances in learning-based control, success in bimanual manipulation increasingly depends on building pipelines that can collect large, high-quality datasets. Most existing approaches to data collection fall into two categories: teleoperated and in-the-wild.

Teleoperation enables high-fidelity demonstrations but re-quires expensive setup and operator training before consistent demonstrations can be produced. For example, ALOHA introduces a low-cost bi-manual leader and follower system and demonstrates robust bi-manual skills. The leader is composed of un-actuated linkages of the same kinematics as follower robot and is controlled by a human operator. Once available, data collected from such systems typically transfers well, since it is collected directly from the target robot. However, such systems typically require a large-footprint leader-follower setup deployed at the data collection site.

By contrast, in-the-wild methods aim to bypass these barriers by collecting data on disembodied end-effectors. For bi-manual manipulation, one handheld paradigm includes two parallel grippers and cameras, allowing users to record bi-manual demonstrations. Similarly, another approach collects data in-the-wild, but using motion capture gloves and deploying anthropomorphic robot hands. But because no robot embodiment is present during collection, significant effort is still required to map these demonstrations onto real robots. Furthermore, demonstrations that prove unfeasible under the kinematic constraints of the complete robot must be discarded.

Recently, a third category has emerged: wearable bi-manual data collection systems. These systems aim to collect robot-relevant data without requiring direct access to a robot, instead using wearable hardware that mirrors the robot's embodiment. By doing so, they reduce embodiment mismatch while retaining the scalability of human demonstrations. This combines the strengths of both prior paradigms: scalable data collection with minimal post-processing, and demonstrations that align closely with robot embodiment. Existing such systems, however, follow the framework of two highly articulated arms, which increases complexity and footprint. In this work, we introduce a new wearable system within this category. By reducing redundancy between the grippers, the disclosed technology achieves a significantly more compact and lightweight design, which makes the manipulator both wearable for data collection and mountable on a robot arm for large-reach policy execution.

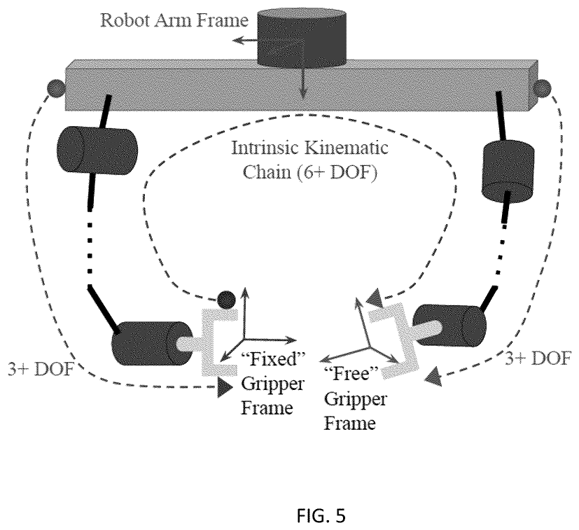

One aspect of the MiniBEE is to realize a compact bimanual manipulator in which each arm individually has reduced mobility, but the combined kinematic chain formed between the two grippers retains sufficient articulation (6+ DOF) to achieve extensive relative mobility. In other words, through careful intrinsic design, the MiniBEE provides a dexterous workspace in which one gripper can be positioned and oriented with respect to the other with high flexibility. Absolute positioning in the environment can then be provided by mounting the system on a standard robotic arm. This concept is illustrated in FIG. 5.

While 6+ intrinsic DOF are the theoretical minimum for arbitrary relative positioning, one finds that the size of the resulting dexterous workspace is strongly influenced by additional kinematic design choices. In this section, we de-scribe our methodology for expanding this workspace while maintaining a low intrinsic DOF count, thereby keeping the MiniBEE compact and lightweight. In the following section, we show how these design properties enable efficient data collection and manipulation via imitation learning.

Algorithm 1 Computation of the KD metric

| Input: Robot description (kinematics and joint limits), target | |
|---|---|
| | workspace size and resolution, singularity threshold ϵ |
| Output: Kinematic Dexterity metric KD ∈ [0, 1] | |
| 1: | Create a grid of points by sampling the target workspace |
| | at the desired resolution (see Fig. 3) |
| 2: | Nₜₒₜₐₗ ← total number of points in grid |
| 3: | N_{valid} ← 0 |
| 4: | for each point pᵢ in the grid do |
| 5: | Compute free gripper pose Pᵢ(pᵢ) using Alg. 2 |
| 6: | Robot pose qᵢ=InverseKinematics(Pᵢ) |
| 7: | if no qᵢ exists then |
| 8: | Skip this point (point is not reachable) |
| 9: | Jᵢ=Jacobian(qᵢ) |
| 10: | Remove Jᵢ columns corresp. to joints near limits |
| 11: | Compute singular values of Jᵢ |
| 12: | if smallest singular value < ϵ then |
| 13: | Skip this point (robot is near a singularity) |
| 14: | Count this point as valid: N_{valid} ← N_{valid} + 1 |
| 15: | KD ← N_{valid} / Nₜₒₜₐₗ |

### Kinematic Analysis

Conventional bimanual robots are described as two independent chains rooted at a shared base. Here, however, one can focus exclusively on the intrinsic DOF of the MiniBEE and their ability to control the relative pose of the two grippers. To this end, we adopt a different convention: the system is modeled as a single kinematic chain, with the base frame coincident with one gripper and the tool frame at the other gripper (FIG. 5).

To evaluate relative dexterity, we introduce the Kinematic Dexterity (KD) metric. Conceptually, the KD metric is designed to test the ability of one gripper to achieve a wide range of useful poses with respect to the other gripper.

Algorithm 2 Computation of free gripper poses

| Input: Workspace point pᵢ | |
|---|---|
| Output: Corresponding free gripper pose Pᵢ | |
| 1: | Compute rotation R(pᵢ) such that approach direction |
| | (z-axis) of free gripper points towards origin |
| 2: | Pᵢ ← (R (pᵢ) , pᵢ) |

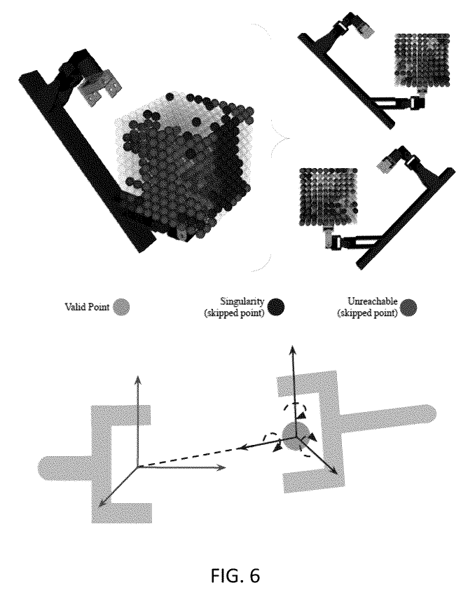

The KD metric is defined as follows. One gripper, referred to as the “fixed” gripper, is treated as stationary and establishes the origin of the coordinate frame. The other gripper, referred to as the “free” gripper, is evaluated based on its ability to attain a diverse set of poses relative to this frame. To this end, we uniformly sample candidate target poses, consisting of both translational and rotational components, within a predefined rectangular region centered on the fixed gripper. For each sampled pose, we employ standard inverse kinematics (IK) to assess feasibility, considering both joint-limit constraints and potential self-collisions. The KD metric is then defined as the proportion of sampled poses that are kinematically feasible under these conditions. The procedure is described in Algorithm 1 and also illustrated in FIG. 6.

Although other formulations of dexterity metrics exist (e.g., manipulability ellipsoids, ergonomics-inspired indices, this disclosure particularly considers the relative positioning and orienting ability most relevant to bimanual tasks. For collision and joint limit-aware IK, one can use the KDL plugin in the MoveIt library, which ensures realistic consideration of such constraints.

### Design Characterization

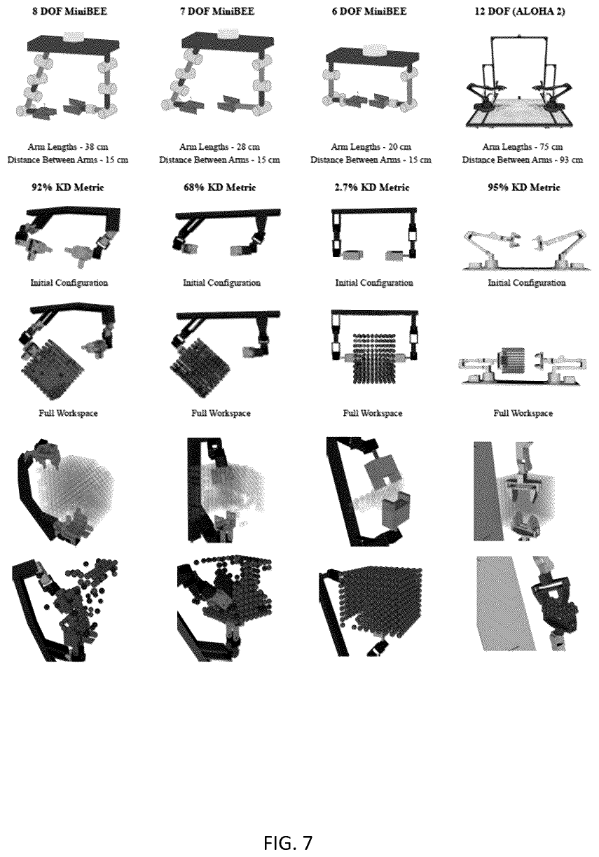

With the KD metric established, we evaluate multiple possible MiniBEE configurations against each other, and also against an existing bimanual platform (FIG. 7). We start with a configuration with 6 intrinsic DOFs, the theoretical minimum sufficient for relative dexterity. However, in the presence of realistic constraints such as self-collisions and joint limits, we find that adding more intrinsic DOFs progressively increases redundancy between the grippers and thus relative dexterity. We also test 7- and 8-DOF configurations of the MiniBEE using the same metric.

For each configuration, we used realistic joint limits and collision geometries based on available off-the-shelf servo-motors (in our case, the Dynamixel X family). Of course, given a number of DOFs, many kinematic configurations are possible. Here, we selected the exact kinematics in each case empirically, based on design intuition. The KD metric allowed to quickly evaluate candidates, and select the best one in each class.

We also compute the KD metric for an existing bimanual system, namely the ALOHA manipulator; with 12 total DOFs between the two arms, it represents a standard of performance in terms of relative dexterity. As such, it provides us with useful grounding information for the capabilities of the MiniBEE. For each system, we applied Algorithm 1 with a fixed 20 cm cubic workspace, defined with one face centered at the fixed gripper and extending toward the free gripper. The same workspace size was used for all MiniBEE variants and the ALOHA system, despite the latter's longer link lengths, to ensure a fair comparison.

Across MiniBEE variants, as expected, we find that more intrinsic DOF yields higher KD scores. The 8-DOF configuration maintained feasible kinematics over most of the workspace, with singularities appearing only when some of the joints become unusable to the robot as they hit their limits. Reducing to 7 or 6 DOFs sharply lowered performance: the 7-DOF system encountered frequent singularities, while the 6-DOF system often failed to find solutions. These results show that some redundancy between grippers is essential for avoiding singularities and preserving dexterity. Without being bound to any particular theory or embodiment, one can select the 8-DOF MiniBEE as offering a useful trade-off between compactness, complexity, and performance, while remaining competitive with more traditional bi-manual systems.

The ALOHA system provides an interesting reference point. Its 12-DOF structure attains a high KD score, with failures arising only from gripper collisions for desired points in the workspace close to the fixed base frame. However, the 8-DOF MiniBEE achieves a comparable score, despite having fewer joints and a much smaller footprint overall. Based on this analysis, the MiniBEE provides high relative dexterity while remaining compact and lightweight enough to be either worn for kinesthetic teaching or mounted on a robot arm for high reach, features that we put to use in the next section.

Having described the overall design of the MiniBEE, we now turn to the goal of achieving dexterous bimanual manipulation. In particular, we rely on imitation learning from human demonstrations, a method recently shown to achieve skilled manipulation in this context.

The fundamental advantage of MiniBEE, as described in the previous section, is that it enables intrinsic bimanual manipulation with fewer DOF than existing alternatives. It is compact, lightweight, and can be worn directly by an operator for kinesthetic data collection. This significantly reduces the difficulty of collecting demonstrations compared to systems with large robot arms, and even more so compared to leader-follower systems requiring four arms in total.

Compared to “in-the-wild” systems where the operator uses robot end-effectors, MiniBEE offers several advantages. First, the relative pose of the grippers is tracked through encoders in the kinematic chain, eliminating the need for external tracking or SLAM during intrinsic manipulation. Second, demonstrations are collected under the full set of kinematic constraints of the real system, ensuring they are feasible on hardware. Finally, MiniBEE is lightweight enough to fit within the payload of standard robot arms, extending reach for larger workspaces, unlike other wearable exoskeletons.

The self-tracking capabilities of MiniBEE apply during intrinsic manipulation, where the object is held by, or transferred between, the grippers. When manipulating an object fixed in an external reference frame, intrinsic encoders alone are insufficient. If one gripper remains fixed, intrinsic DOFs still suffice, but if both must move with respect to the external frame, additional tracking is needed, similar to in-the-wild systems. In this section, we describe our setup for data collection and policy training, and illustrate MiniBEE's performance on real-world dexterous bimanual tasks.

### Data Collection and Policy Training

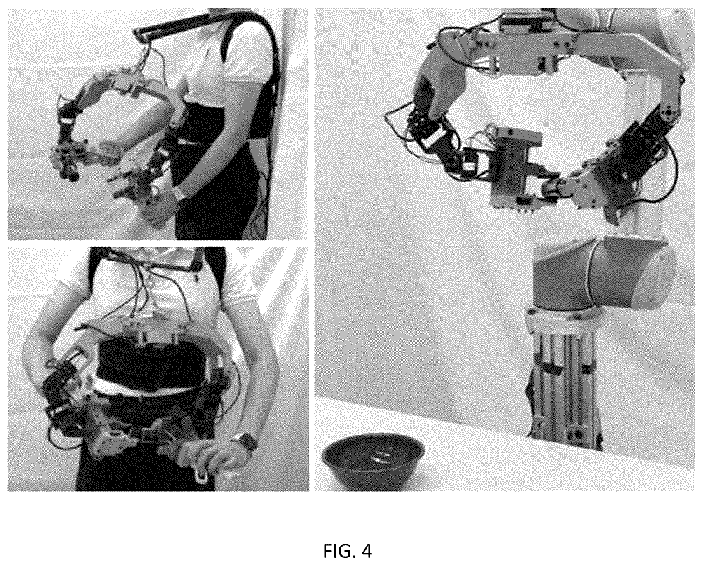

To collect data for policy learning, we leverage the fact that the same device can be used for data collection and policy deployment. The MiniBEE is worn and directly controlled by a human operator. A custom back brace (FIG. 4) supports the weight of the MiniBEE and stabilizes the system during demonstrations. Two ergonomic handles allow the operator to control the arms, and integrated triggers provide continuous control of the grippers, enabling natural modulation of grasp force and aperture throughout each task. The parallel grippers are equipped with RGB cameras, and the joints are driven by servos with embedded encoders to record joint angles.

As mentioned earlier in this disclosure, we focus on the intrinsic dexterity between the two grippers. Therefore, we do not collect information about the global positioning of the MiniBEE relative to an external fixed frame in the environment. As such, the components of a task where an object is first acquired from the environment, or placed back after task completion, are executed open loop. However, the entire bimanual component of the task is autonomous, using a policy based on the data described here.

Relative gripper poses are continuously self-tracked during demonstration collection, and all sensor signals are logged throughout the trajectory at 40 Hz. The observation space consists of RGB images from two cameras mounted on the grippers, as shown in FIG. 4. The images are streamed at 640*480, then cropped into a 4:3 aspect ratio, and finally down sampled to 320*240. The joint angles are recorded from the encoders embedded in the servos. The action space comprises binary commands for gripper aperture and continuous commands for arm joint positions, directly derived from the operator's handle inputs. This representation enables the policy to reproduce smooth, continuous manipulation behaviors rather than discrete open/close events.

To address the distribution shift between training and deployment—where handles are visible in demonstration observations but absent during robot execution—we additionally collect a small set of replayed trajectories, which are generated by the recorded data at 20 Hz. These provide handle-free visual inputs while preserving the underlying motion, helping the learned policy adapt to the deployment setting.

For policy training, we use Diffusion Policy (DP), which models the trajectory distribution with a conditional denoising diffusion process. In our implementation, we use a longer observation horizon for low-dimensional state inputs (e.g., gripper poses and joint angles) to better capture temporal dependencies, while restricting image inputs to the most recent frame for computational efficiency.

### Experiments and Performance

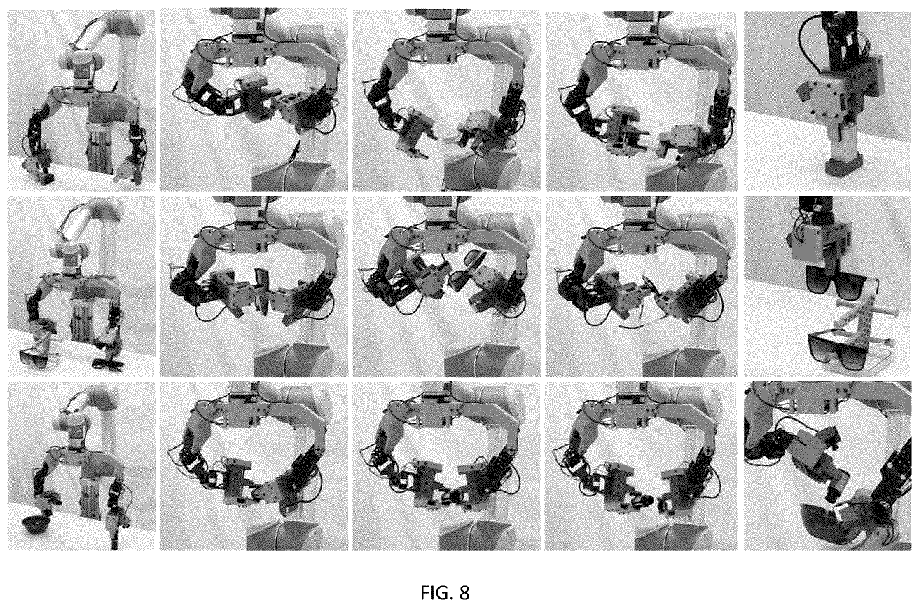

We used the method above on a total of 3 tasks, each of them requiring bimanual dexterity for completion. All tasks are illustrated in FIG. 8.

Task 1: Object re-orientation via double handoff. Here, the MiniBEE re-orients a grasped object by first transferring it to the other gripper, then transferring it back to the original gripper in a different pose. Such re-orientation is commonly needed in many applications, where the grasp originally available for an object is not the same one needed for later use.

Task 2: Unfolding sunglasses. Here, the MiniBEE holds a folded pair of sunglasses in one gripper, then uses the other gripper to unfold the glasses, followed by placing the unfolded glasses on a shelf. This task highlights nonprehensile relative dexterity.

Task 3: Unscrewing and emptying bottle. Here, the MiniBEE uses both gripper to first unscrew a bottle, then to pour its contents into a bowl. This task highlights both prehensile and non-prehensile relative dexterity,

For each of these tasks, we collect a total of N=45 demonstrations via the wearable MiniBEE as described in the previous section. We then augment the training set with M=5 replay trajectories. We use these demonstrations to train autonomous policies for all the bimanual components of the tasks. Finally, we mount the MiniBEE on a robot arm, and test autonomous execution of the complete tasks.

Our results show a 20/20 success rate for Task 1, 19/20 success for Task 2, and 18/20 success rate for Task 3. For Task 2, the lone failure was due to an imprecise grasp of the temples (or folding arms) of the glasses. For Task 3, both failures were due to incomplete lid unscrewing. Representative executions of all tasks are shown in FIG. 5. These examples showcase the ability of the MiniBEE system to achieve dexterous bimanual manipulation based on demonstrations collected kinesthetically via a wearable system, leveraging its compact and lightweight nature.

### Conclusion

In this disclosure, we have introduced MiniBEE, a concept for a new form factor for bimanual manipulation. MiniBEE attempts to combine the best features of both in-the-wild and leader-follower systems for data collection of bimanual manipulation. Like leader-follower systems, it comprises a two-gripper kinematic chain allowing self-tracked relative poses of the two grippers. However, through careful kinematic design analysis, MiniBEE uses a reduced articulation model, while still maintaining a level of dexterity (computed based on the relative positioning ability of the two grippers) comparable to larger systems that use many more articulations.

This kinematic approach in turn enables a compact and lightweight design of the overall MiniBEE, which can be either worn directly by an operator (for kinesthetic data collection) or mounted on a robot arm (for high reach during autonomous policy execution). We demonstrate both of these modes by collecting kinesthetic data and training policies for multiple tasks requiring bimanual dexterity, both prehensile and non-prehensile. Our results show that the MiniBEE is indeed kinematically capable of such tasks, executing the policies trained from wearable data collection with high success rates.

### Aspects

The following Aspects are illustrative only and do not limit the scope of the present disclosure or the appended claims. Any part or parts of any one or more Aspects can be combined with any part or parts of any one or more other Aspects.

Aspect 1. A manipulator, comprising: a support arm and an arm support mount associated with the support arm; a first arm and a first end effector associated with the first arm, the first arm comprising a plurality of joints arranged such that the first arm is moveable with a plurality of degrees of freedom, the plurality optionally being from 3 to 6 degrees of freedom; a second arm and a second end effector associated with the second arm, the second arm comprising a plurality of joints arranged such that the second arm is moveable with a plurality of degrees of freedom, the plurality optionally being from 3 to 6 degrees of freedom, and the first arm and the second arm extending from the arm support mount.

A manipulator can be configured to be portable or even mounted on or worn by a user. One example is provided in FIG. 4. This is not a requirement, as a manipulator can be in a fixed position, for example at a location within a factory or other facility. As provided herein, a manipulator according to the present disclosure can be utilized in a bimanual manner. A manipulator can include one or more actuators—such as servos, and the like—that control motion of one or more components of the manipulator.

Aspect 2. The manipulator of Aspect 1, wherein at least one of the first end effector or the second end effector comprises a gripper.

Aspect 3. The manipulator of any one of Aspects 1-2, wherein at least one of the first arm or the second arm comprises from 2 to 6 joints.

Aspect 4. The manipulator of any one of Aspects 1-3, wherein the support arm comprises from 2 to 6 joints.

Aspect 5. The manipulator of any one of Aspects 1-4, wherein the support arm is moveable with a plurality of degrees of freedom.

Aspect 6. The manipulator of any one of Aspects 1-5, wherein the first arm and the second arm are both movable with an equal number of degrees of freedom.

Aspect 7. The manipulator of any one of Aspects 1-6, further comprising at least one motor configured to effect motion of at least one of the support arm, the first arm, or the second arm.

Aspect 8. The manipulator of any one of Aspects 1-7, further comprising a control device and wherein at least one joint of at least one of the first arm or the second arm is adjustable under control of the control device.

Aspect 9. The manipulator of any one of Aspects 1-8, wherein (1) for at least 50% of the N points when a defined three-dimensional workspace is discretized into N points, (2) when one of the first end effector or the second end effector is fixed at a given point of the N points, the other of the first end effector or the second end effector is orientable by 450 along any axis at the given point.

Aspect 10. The manipulator of any one of Aspects 1-8, wherein (1) for at least 90% of the N points when a defined three-dimensional workspace is discretized into N points, (2) when one of the first end effector or the second end effector is fixed at a given point of the N points, the other of the first end effector or the second end effector is orientable by 450 along any axis at the given point.

Aspect 11. The manipulator of any one of Aspects 1-10, wherein at least one of the support arm, the first arm, or the second arm comprises a plurality of segments, and at least two of the segments differ in their lengths.

Aspect 12. The manipulator of Aspect 11, wherein at least one of the first arm or the second arm comprises a plurality of segments, and at least two of the segments differ in their lengths.

Aspect 13. The manipulator of any one of Aspects 1-12, wherein the arm support mount is moveable relative to the support arm.

Aspect 14. A manipulator, comprising: an articulated support arm; an articulated first arm extending from the articulated support arm, the articulated first arm comprising a first end effector; and an articulated second arm extending from the articulated support arm, the articulated second arm comprising a second end effector, the articulated first arm and the articulated second arm being arranged so as to define a plurality of degrees of freedom between the articulated first arm and the articulated second arm, the plurality of degrees of freedom optionally being from 6 to 12 degrees of freedom.

Aspect 15. The manipulator of Aspect 14, wherein at least one of the articulated first arm and the articulated second arm comprises a plurality of segments, and at least two of the segments differ in their lengths.

Aspect 16. The manipulator of any one of Aspects 14-15, further comprising at least one motor configured to effect motion of at least one of the articulated support arm, the articulated first arm, or the articulated second arm.

Aspect 17. The manipulator of any one of Aspects 14-16, further comprising a control device and wherein at least one of the articulated first arm or the articulated second arm is adjustable under control of the control device.

Aspect 18. The manipulator of any one of Aspects 14-17, wherein at least one of the first end effector or the second end effector comprises a gripper.

Aspect 19. A method, comprising operating a manipulator of any one of Aspects 1-18 so as to effect a motion of an object engaged by the manipulator. Such motion can comprise, for example, placement, removal, twisting, tying, and the like.

Aspect 20. The method of Aspect 19, wherein the motion comprises at least one of translational and rotational motion.

Aspect 21. A method, comprising: acquiring data related to a position or state of a component of a manipulator; causing input of the data into a trained classification model; determining, based on the data and via the classification model, a first characteristic value associated with a component of the manipulator; comparing the first characteristic value to a first target characteristic value; and causing adjustment of a parameter of the manipulator such that the first characteristic value of the component of the manipulator approaches the first target characteristic value.

Adjusting a parameter of the manipulator can comprise, for example, causing the manipulator to grip an object, release an object, rotate a joint of the manipulator, and the like.

Data can be, for example, image data, position data, angle data—such as the angle of a joint, and the like. The manipulator component can be, for example, a joint, an end effector, an arm, a support, and the like.

A characteristic value can be, for example, a value indicative of a state; a state can comprise a pose, a location, an orientation, and the like. The method can be performed on or using a manipulator according to the present disclosure.

As described elsewhere herein, a manipulator according to the present disclosure can comprises one or more sensors. Such a sensor can be configured to, for example, collect visual information regarding a state of the manipulator or of any one or more components of the manipulator. As an example, a sensor can be a camera, which camera can be mounted on a gripper.

A sensor can also be, for example, an encoder that collects information related to an angle of one or more joints of the manipulator; such an encoder can be incorporated into a servo that drives a given joint. In this way, a manipulator can function as a mechanism for data collection with self-tracking dexterity.

A manipulator can operate in accordance with a given policy, which policy can be a trained policy. Such a policy can be, for example, created based on a training set.

Such a training set can include, for example, trajectories of one or more components of a manipulator.

One can collect demonstration data using a wearable or otherwise operable manipulator, which training set can be augmented with replay trajectories. The demonstrations can then be used to train autonomous policies for the components of a given task. Policy training can be achieved by, for example, modeling a trajectory distribution. Such modeling can include a denoising diffusion process.

As an example—and as described herein—a manipulator can operate in accordance with a trained policy or model. Such a policy or model can be trained via imitation learning, such as learning from human demonstration. An imitation learning policy can be one that utilizes a proprioceptive component of a demonstration.

Aspect 22. A system, comprising: a manipulator (which manipulator can be a manipulator according to the present disclosure); one or more processors; and a memory storing instructions that, when executed by the one or more processors, cause the manipulator to operate in accordance with a trained policy. Such a policy can be, for example, a trained machine-learning model. A policy can be, for example, trained on data collection, which data collection can be wearable data collection. A policy can be, for example, trained on data related to one or more demonstrations, which demonstrations can comprise performance of one or more tasks. Such demonstrations can be human-performed, although this is not a requirement. Data can be collected, for example during a demonstration, such as performing one or more tasks. Such a demonstration can be a wearable demonstration. States—such as poses and positions—can be tracked during demonstration collection. Such tracking can be via self-tracking, for example.

Aspect 23. The system of Aspect 22, further comprising a sensor, the sensor configured to acquire information regarding a state of at least one of (1) any one or more components of the manipulator or (2) an object external to the manipulator. As an example, a sensor can acquire information regarding the angle of a joint of the manipulator; a sensor can also acquire information regarding a location, an orientation, or other characteristic of the manipulator and/or an object with which the manipulator may interact. Sensors can include, without limitation, a force sensor, a torque sensor, a tactile array, an inertial sensor, a camera, a proximity sensor, a depth sensor, and the like.

Aspect 24. The system of Aspect 23, further comprising a control module, the control module configured to receive data from the sensor. A control module can, for example, utilize the received data and generate a state of the manipulator and/or a state of a component of the manipulator. Such a state can comprise any one or more of a pose, a position, a force, and the like.

Aspect 25. A method, comprising: acquiring data related to a manipulator; processing the data to analyze a manipulator state; and causing operation of a manipulator in accordance with a trained policy. Processing can be performed by, for example, a machine learning model. Such a machine learning model can be trained using demonstration data.

A trained policy can be trained on demonstration data. The operation of the manipulator can be in response to the analyzed manipulator state. Data can be analyzed with a machine learning model; such a model can be trained, for example, on demonstration data.

Aspect 26. A non-transitory computer-readable medium storing instructions that, when executed by one or more processors, cause the one or more processors to: acquire data related to a manipulator; process the data to analyze a state of the manipulator; and cause operation of the manipulator in accordance with a trained policy. The trained policy can be trained on demonstration data. A manipulator can be, for example, a manipulator according to the present disclosure.

What is claimed:

1. A manipulator, comprising:
a support arm and an arm support mount associated with the support arm;
a first arm and a first end effector associated with the first arm,
the first arm comprising a plurality of joints arranged such that the first arm is moveable with a plurality of degrees of freedom, the plurality optionally being from 3 to 6 degrees of freedom;
a second arm and a second end effector associated with the second arm,
the second arm comprising a plurality of joints arranged such that the second arm is moveable with a plurality of degrees of freedom, the plurality optionally being from 3 to 6 degrees of freedom, and
the first arm and the second arm extending from the arm support mount.

2. The manipulator of claim 1, wherein at least one of the first end effector or the second end effector comprises a gripper.

3. The manipulator of claim 1, wherein at least one of the first arm or the second arm comprises from 2 to 6 joints.

4. The manipulator of claim 1, wherein the support arm comprises from 2 to 6 joints.

5. The manipulator of claim 1, wherein the support arm is moveable with a plurality of degrees of freedom.

6. The manipulator of claim 1, wherein the first arm and the second arm are both movable with an equal number of degrees of freedom.

7. The manipulator of claim 1, further comprising at least one motor configured to effect motion of at least one of the support arm, the first arm, or the second arm.

8. The manipulator of claim 1, further comprising a control device and wherein at least one joint of at least one of the first arm or the second arm is adjustable under control of the control device.

9. The manipulator of claim 1, wherein (1) for at least 50% of the N points when a defined three-dimensional workspace is discretized into N points, (2) when one of the first end effector or the second end effector is fixed at a given point of the N points, the other of the first end effector or the second end effector is orientable by 450 along any axis at the given point.

10. The manipulator of claim 1, wherein (1) for at least 90% of the N points when a defined three-dimensional workspace is discretized into N points, (2) when one of the first end effector or the second end effector is fixed at a given point of the N points, the other of the first end effector or the second end effector is orientable by 450 along any axis at the given point.

11. The manipulator of claim 1, wherein at least one of the support arm, the first arm, or the second arm comprises a plurality of segments, and at least two of the segments differ in their lengths.

12. The manipulator of claim 11, wherein at least one of the first arm or the second arm comprises a plurality of segments, and at least two of the segments differ in their lengths.

13. The manipulator of claim 1, wherein the arm support mount is moveable relative to the support arm.

14. A manipulator, comprising:
an articulated support arm;
an articulated first arm extending from the articulated support arm,
the articulated first arm comprising a first end effector; and
an articulated second arm extending from the articulated support arm,
the articulated second arm comprising a second end effector,
the articulated first arm and the articulated second arm being arranged so as to define a plurality of degrees of freedom between the articulated first arm and the articulated second arm,
the plurality of degrees of freedom optionally being from 6 to 12 degrees of freedom.

15. The manipulator of claim 14, wherein at least one of the articulated first arm and the articulated second arm comprises a plurality of segments, and at least two of the segments differ in their lengths.

16. The manipulator of claim 14, further comprising at least one motor configured to effect motion of at least one of the articulated support arm, the articulated first arm, or the articulated second arm.

17. The manipulator of claim 14, further comprising a control device and wherein at least one of the articulated first arm or the articulated second arm is adjustable under control of the control device.

18. The manipulator of claim 14, wherein at least one of the first end effector or the second end effector comprises a gripper.

19. A method, comprising operating a manipulator according to claim 1 so as to effect a motion of an object engaged by the manipulator, the motion optionally comprising at least one of translational and rotational motion.

20. A method, comprising: acquiring data related to a manipulator according to claim 1; processing the data to analyze a manipulator state; and causing operation of a manipulator in accordance with a trained policy.
